(19) United States
(12) Patent Application Publication
(10) Pub. No.: US 2010/0184001 A1
(43) Pub. Date: Jul. 22, 2010

(54) AREA-SPECIFIC DENTAL INSTRUMENT

(76) Inventor: Tamara L. Beach, Chattanooga, TN (US)

Correspondence Address: MUSKIN & CUSICK LLC, 100 West Main Street, SUITE 205, Lansdale, PA, 19446, US

(21) Appl. No.: 12/357,377

(22) Filed: Jan. 21, 2009

(51) Int. Cl. A61C 17/00

(52) U.S. Cl. 433/143

(57) ABSTRACT

An area-specific dental instrument is provided, which comprises an arcuate S-shaped shank and an arcuate blade further comprising a sharpened convex surface. This instrument can be capable of cleaning plaque and calculus from the lingual surfaces of anterior teeth and concave surfaces between teeth at the cemento-enamel junction.

### CROSS REFERENCE TO RELATED APPLICATIONS

This application claims benefit to provisional application No. 60/021,660, which is incorporated by reference herein in its entirety.

### FIELD OF THE INVENTION

The present device is an area-specific dental instrument designed to facilitate access the lingual surface of anterior teeth and the surfaces between teeth including the cemento-enamel junction.

### BACKGROUND

It is well-established that teeth require periodic professional cleaning in order to maintain tooth and gum health. Teeth are irregularly shaped objects, found generally in close proximity to one another and located in the close confines of the mouth. Some tooth surfaces are very difficult for dental professionals to access and clean. One such surface is the concave surface located between molars at the cemento-enamel junction. Another such area is the lingual surfaces of anterior teeth. These parts of the tooth are difficult to reach with commonly used instruments comprising C-shaped working ends comprising either no blade, or a flat blade.

What is needed is an area-specific dental instrument capable of accessing and removing plaque and calculus from the concave surfaces between molars at the cemento-enamel junction and the lingual surfaces of anterior teeth.

### SUMMARY OF THE INVENTION

It is an aspect of the present device to provide an instrument capable of accessing and removing plaque and calculus from the concave surfaces between molars at the cemento-enamel junction and the lingual surfaces of anterior teeth.

The above aspect can be obtained by a an area-specific dental instrument an elongated handle having a first end and a second end, a first working end connected to the first end of the elongated handle, the first working end further comprising a shaft having a first end and a second end, wherein the first end of the shaft is connected to the first end of the elongated handle, an arcuate, S-shaped shank having a first end and second end, wherein the first end of the arcuate, S-shaped shank is connected to the second in of the shaft and an arcuate blade, further comprising a convex cutting shape connected to, the second end of the arcuate, S-shaped shank.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective view of a double-ended area-specific dental instrument according to an embodiment;

FIG. 2A is an enlarged perspective view of the working end of an area-specific dental instrument, in a vertical position, displaying a shaft, an arcuate, S-shaped shank and an arcuate blade with the point of the blade facing forward, according to an embodiment;

FIG. 2B is an enlarged perspective view of the working end of an area-specific dental instrument, as displayed in FIG. 2A, which has been rotated counter-clockwise ninety (90) degrees, according to an embodiment;

FIG. 2C is an enlarged perspective view of the working end of an area-specific dental instrument, as displayed in FIG. 2A, which has been rotated counter-clockwise one hundred eighty (180) degrees, according to an embodiment;

FIG. 2D is an enlarged perspective view of the working end 201 of an area-specific dental instrument, as displayed in FIG. 2A, which has been rotated counter-clockwise two hundred seventy (270) degrees, according to an embodiment;

FIG. 3 is an illustrational view of the present device being utilized to clean the concave surface between two molars at the cemento-enamel junction of a particular tooth, according to an embodiment;

FIG. 4 is an enlarged perspective view of a working end of the area-specific dental instrument, according to an embodiment; and

FIG. 5 is an enlarged perspective view of the tip of the present device displaying its blade and part of it shank, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,”“vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

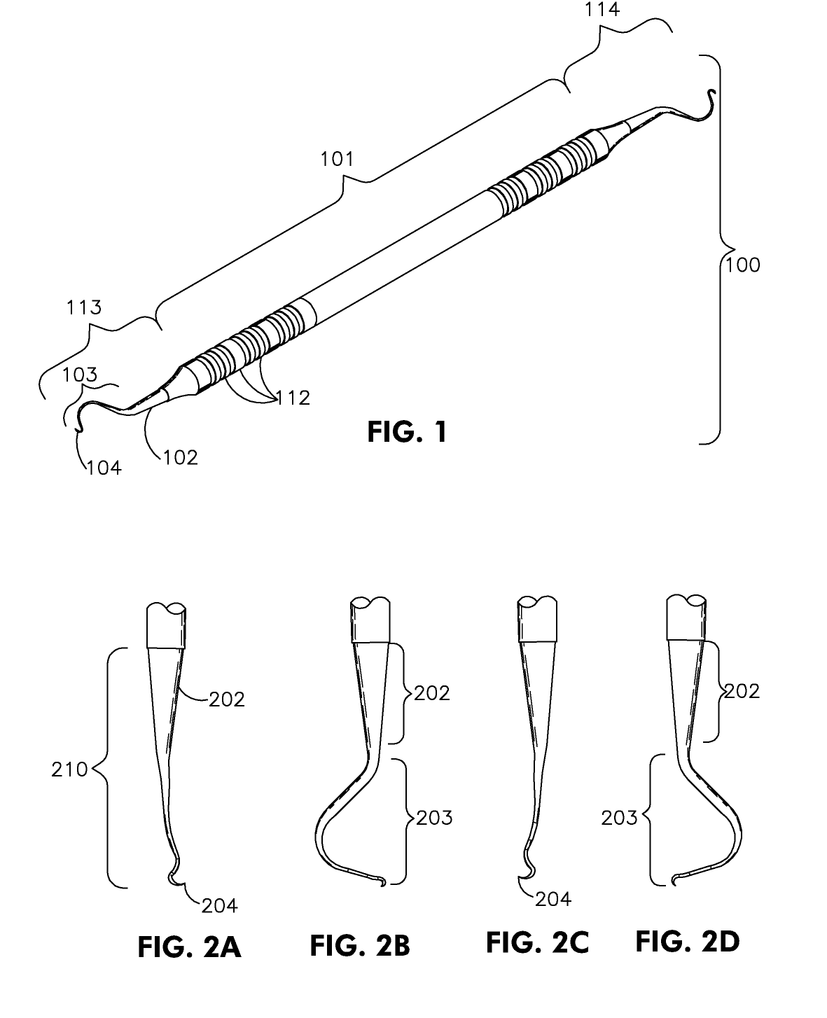

FIG. 1 is a perspective view of a double-ended area-specific dental instrument 100, according to an embodiment.

The double-ended area-specific dental instrument 100, as depicted in FIG. 1, can be comprised of an elongated handle 101. The cross-sectional shape of this handle can be cylindrical, triangular, octagonal or any other shape suitable to sufficiently control the double-ended area-specific dental instrument 100. The instrument 100 is depicted in FIG. 1 as having a cylindrical cross-sectional shape with grooves 112 carved into its surface to facilitate gripping.

The double-ended area-specific dental instrument 100, as depicted in FIG. 1, can be composed of stainless steel, titanium, plastic, or any other suitable material known to those of average skill in the relevant art, or a combination of such materials.

The double-ended area-specific dental instrument 100 can comprise a working end at only one end of the handle 101, however, the preferred embodiment, as shown in FIG. 1, comprises a first working end 113 on one end of the handle 101 and a second working end 114 on the other end, which is the mirror image of the first working end 113. This configuration allows the user to clean both sides of a particular tooth (not pictured) without changing instruments.

Each working end 113 and 114 comprises a shaft 102, which can be connected to one end of the handle 101. The shaft 102 can taper from its thickest width at the point where it connects to the handle 101 to its thinnest where it meets the arcuate, S-shaped shank 103, which itself, is connected to an arcuate blade 104 at its opposite end.

FIG. 2A is an enlarged perspective view of the working end 210 of an area-specific dental instrument, in a vertical position, displaying a shaft 202, an arcuate, S-shaped shank and an arcuate blade 204 with the point of the blade 204 facing forward, according to an embodiment.

From this viewpoint, the arcuate blade 204 can easily be viewed. In this embodiment the arcuate blade angles slightly downward from the end of the shank. This angle allows the user to hold the instrument at an angle and still maximize the arcuate blade's 204's contact with the tooth surface being cleaned (not pictured). This figure displays the arcuate blade 204 pointing out toward the viewer.

FIG. 2B is an enlarged perspective view of the working end 210 of an area-specific dental instrument, as displayed in FIG. 2A, which has been rotated counter-clockwise ninety (90) degrees, according to an embodiment.

This viewpoint displays the arcuate, S-shaped shank 203 of an area-specific dental instrument, according to an embodiment. This shank can allow the user to access areas on the surface of teeth which are not easily accessible. For example, the long, narrow, lower portion of the arcuate, S-shaped shank 203 can be used to position the arcuate blade 204 between the teeth to clean the surface areas of these teeth including the cemento-enamel junction.

FIG. 2C is an enlarged perspective view of the working end 210 of an area-specific dental instrument, as displayed in FIG. 2A, which has been rotated counter-clockwise one hundred eighty (180) degrees, according to an embodiment.

This viewpoint displays the same angle of the arcuate blade 204 as displayed in FIG. 2A, but from the reverse angle.

FIG. 2D is an enlarged perspective view of the working end 201 of an area-specific dental instrument, as displayed in FIG. 2A, which has been rotated counter-clockwise two hundred seventy (270) degrees, according to an embodiment.

This viewpoint displays the same angle of the arcuate blade 204 as displayed in FIG. 2B, but from the reverse angle.

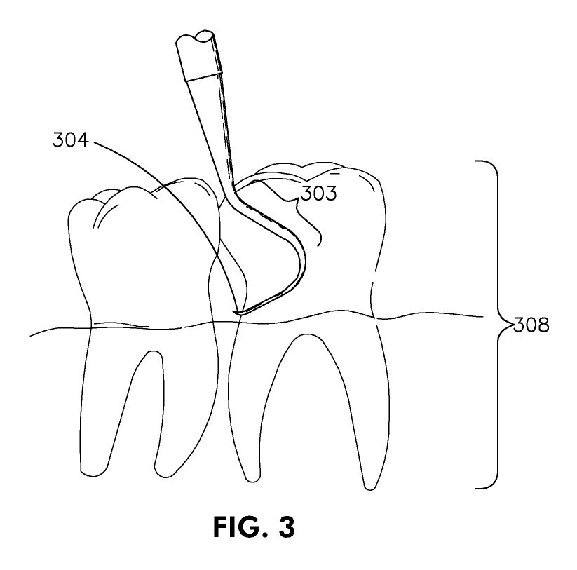

FIG. 3 is an illustrational view of the present device being utilized to clean the concave surface between two molars at the cemento-enamel junction of a particular tooth 308, according to an embodiment.

This view displays how the arcuate, S-shaped shank 303 allows the present instrument can be utilized to access hard to reach surface areas of the tooth being cleaned 308.

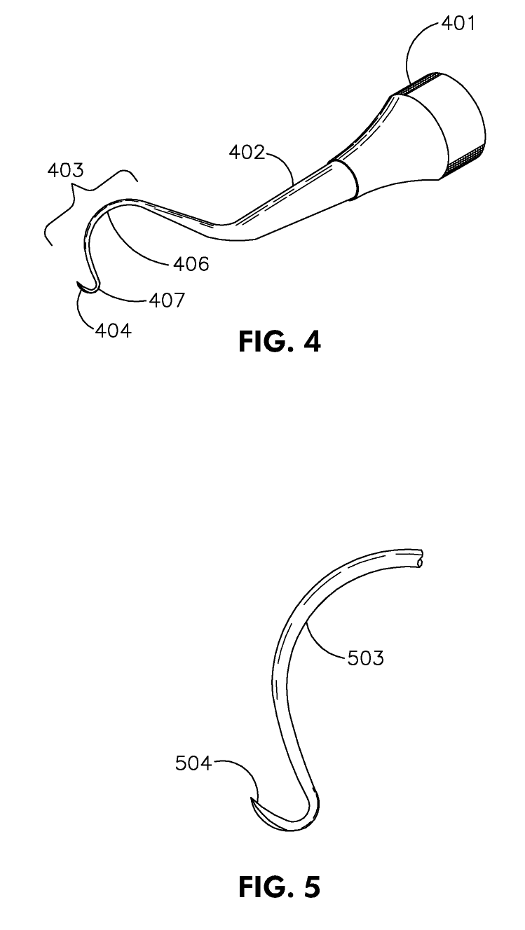

FIG. 4 is an enlarged perspective view of a working end of the area-specific dental instrument, according to an embodiment. This working end can be comprised of several parts connected together or formed from a single piece of material such as stainless steel or some other suitable material.

This viewpoint displays the various parts of a working end of an area-specific dental instrument, according to an embodiment. The working end can be attached to the an elongated handle 401. The working end can comprise a tapered shaft 402, aligned with the central longitudinal axis of the elongated handle 401. The arcuate, S-shaped shank 403 can comprise a large curve 406, which can function to both position the arcuate blade 404 and provide clearance for the instrument to work around a particular tooth (not pictured). The arcuate, S-shaped shank 403 can also comprise a small curve 407, which also helps to position the arcuate blade 404 and act as a platform for the blade 404.

FIG. 5 is an enlarged perspective view of the tip of the present device displaying its blade and part of it shank, according to an embodiment.

This viewpoint provides a close-up view of the arcuate blade 504, which can be a small, quarter-round edge at the very tip of an arcuate, S-shaped shank 503. This arcuate blade can have a convex cutting shape so as to maximize its contact with concave surfaces, which are often found on the surfaces of teeth, particularly the lingual surfaces of anterior teeth and the cemento-enamel junction.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. an area-specific dental instrument comprising:
an elongated handle having a first end and a second end;
a first working end connected to the first end of the elongated handle;
the first working end further comprising a shaft having a first end and a second end, wherein the first end of the shaft is connected to the first end of the elongated handle;
an arcuate, S-shaped shank having a first end and second end, wherein the first end of the arcuate, S-shaped shank is connected to the second in of the shaft; and
an arcuate blade, further comprising a convex cutting shape connected to, the second end of the arcuate, S-shaped shank.

2. The area-specific dental instrument as recited in claim 1, wherein the second end of the elongated handle is attached to a second working end which is identical to the first working end except the second end is the mirror image of the first working end with reversed curves and angles.

3. The area-specific dental instrument as recited in claim 1, wherein the arcuate blade is convex so it can conform to the concave surfaces often found on the surfaces of teeth.

4. The area-specific dental instrument as recited in claim 1, wherein the shaft, the arcuate, S-shaped shank and the arcuate blade are composed of a single piece of material.

5. The area-specific dental instrument as recited in claim 1, wherein the elongated handle has a circular cross-sectional shape.

6. The area-specific dental instrument as recited in claim 1, wherein the elongated handle has an octagonal cross-sectional shape.

7. The area-specific dental instrument as recited in claim 1, wherein the elongated handle has a triangular cross-sectional shape.

8. The area-specific dental instrument as recited in claim 1, wherein the scaler is composed of stainless steel.

9. The area-specific dental instrument as recited in claim 1, wherein the scaler is composed of titanium.

10. The area-specific dental instrument as recited in claim 1, wherein the scaler is composed of plastic.
